(19) United States
(12) Patent Application Publication
(10) Pub. No.: US 2023/0286092 A1
(43) Pub. Date: Sep. 14, 2023

(54) INTELLIGENT TOOL HOLDER

(71) Applicant: National Chung Cheng University, Chiayi (TW)

(72) Inventors: Her-Terng Yau, Chiayi (TW); Dian-Ying Cai, Chiayi (TW); Song-Wei Hong, Chiayi (TW)

(21) Appl. No.: 18/118,590

(22) Filed: Mar. 7, 2023

(30) Foreign Application Priority Data
Mar. 14, 2022 (TW) 111109293
Mar. 24, 2022 (TW) 111111074
Mar. 24, 2022 (TW) 111111088

(51) Int. Cl. B23Q 3/155

(52) U.S. Cl. CPC B23Q 3/15546

(57) ABSTRACT

An intelligent tool holder includes a tool-holder main body and a sensing reading device. The tool-holder main body includes a connecting portion which is provided with a plurality of embedded holes respectively embedded with a sensing element therein to kinetically detect sensed data including stress and strain of the tool-holder main body which are correspondingly formed as being loaded from the processing tool. The sensing reading device includes a housing to outwardly cover the connecting portion of the tool-holder main body. A sensing reading module is provided to read the sensed data of the sensing element transmitted therefrom. An active sensing method having a particular rotational angle is provided, thereby increasing sensing properties, lowering the coupling effects and detecting a global forced condition in a processing procedure.

### BACKGROUND OF THE INVENTION

### Field of the Invention

The invention relates to an intelligent tool holder, and in particular relates to an intelligent tool holder having a tool-holder main body which is installed with several sensors therein.

### Description of the Related Art

Conventionally, tools play important roles in the production and manufacturing processes. When a large number of tools are used in these processes, the operations connected therewith are complicated, and therefore the optimal use management of the tools are important to effectively reduce production costs and time. Nowadays, the current factories wish to have automatic and intelligent productions and thereby to monitor real-time machining processes and control and to obtain real-time tool information. Thus, machine equipment utilization rate and product competitiveness can be effectively promoted.

As to current techniques in the manufacturing fields, a sensing mechanism is often mounted on a machine tool spindle or a work table, thus to use the sensors disposed between the work table and a work piece to detect a cutting force. Besides, the sensors disposed on a holding device are utilized to detect a rotatory cutting force, or the sensors directly disposed on a tool holder are utilized to obtain more precise cutting force. The real-time dynamic force sensing signals are utilized to monitor the tool machining processes. In general, the sensors are strain-gauge-like sensors adhered to the surface of the tool holder, thereby to monitor particular parameters to feedback a cutting control.

However, the current techniques still have drawbacks as follows: the adhered sensors are easily peeled off the surface of the tool holder; multiple strain-gauge-like sensors adhered to the surface of the tool holder are operatively required in the sensing mechanism; the assembly and integration processes of adhering the sensors to the tool holder are complicated due to the limitation of its different directions and positions; the decoupling process is complicated and required of lots of computation by algorithm analysis; the application of sensors has a low accuracy and the axial detections are easily interfered to each other; and ten to twelve strain-gauge-like sensors are generally used for general cases and thus the total cost is high.

### BRIEF SUMMARY OF THE INVENTION

The purpose of the present invention is to provide an intelligent tool holder with a sensing mechanism having multiple sensing elements which are installed in a connecting portion of a tool-holder main body. An active sensing method having a particular rotational angle is provided, thereby increasing sensing properties, lowering the coupling effects and detecting a global forced condition in a processing procedure.

Another purpose of the present invention is to provide an intelligent tool holder with a sensing mechanism having multiple sensing elements which are installed in a connecting portion of a tool-holder main body through a simplified assembling process, thus to effectively integrate the sensed information, to increase the detection accuracy of sensors, and to reduce the total cost.

To achieve these purposes, the present invention provides an intelligent tool holder which comprises a tool-holder main body. The tool-holder main body comprises a connecting portion which is utilized to connect a processing tool and provided with a plurality of embedded holes respectively embedded with a sensing element therein to kinetically detect sensed data including stress and strain of the tool-holder main body which are correspondingly formed as being loaded from the processing tool.

The intelligent tool holder of the present invention provides a multi-axis decoupling and high-sensitivity sensing mechanism, applying a bending-moment loading and a torque loading to perform a stratified detection, cooperating with a piezoelectric active power of the piezoelectric elements, increasing sensing properties and lowering the coupling effects, and using the symmetrically-configured piezoelectric elements to detect the global forced condition in the processing procedure.

In comparison to prior skills, the intelligent tool holder of the present invention provides features as follows: the sensing elements are embedded in the intelligent tool holder so that a stable and reliable assembled structure is provided; the assembly and integration of the intelligent tool holder are simplified by utilizing a single, independent piezoelectric element for detection in a sensing mechanism, so that the sensing mechanism can be applied to different kinds of tool holders; the designed decoupling is directed to the forced direction so that the decoupling operation can be easily performed; the arrangement of the sensing elements embedded in the intelligent tool holder can provide a high-accuracy detection and the mutual interference formed between the axial detections can be prevented; the piezoelectric element can be acquired at relatively little cost and the quantity demand is few, so that the total cost can be greatly reduced.

A detailed description is given in the following embodiments with reference to the accompanying drawings.

### BRIEF DESCRIPTION OF THE DRAWINGS

The aforementioned and other technical contents of the invention can be more clearly understood by reading the subsequent detailed description and embodiments with references made to the accompanying drawings, and the same elements in each of embodiments will be designated as same symbols, wherein:

FIG. 1 is a schematically exploded view of a sensing reading device of a first embodiment of an intelligent tool holder of the present invention;

FIG. 2 is a schematically exploded view of the sensing reading device of the intelligent tool holder of the present invention observed from another view angle;

FIG. 3 is a perspective appearance view of the sensing reading device of the intelligent tool holder of the present invention;

FIG. 4 is a bottom view of the intelligent tool holder of the present invention;

FIG. 5 is a schematically exploded view of the sensing reading device of the intelligent tool holder of the present invention;

FIG. 6 is a circuit block diagram of the intelligent tool holder of the present invention;

FIG. 7 is a schematic view of an exemplary example of an intelligent tool holder of the present invention;

FIG. 8 is a schematic view of embedded locations and placement angles of sensors of a second embodiment of an intelligent tool holder of the present invention;

FIG. 9 is a schematic view of the embedded locations and the placement angles of sensors of an intelligent tool holder of the second embodiment of the present invention;

FIG. 10 is a schematic view of values and directions of a maximum principal stress of the intelligent tool holder of the second embodiment of the present invention while being loaded from the pure torsion;

FIG. 11A is a schematic view of the intelligent tool holder of the second embodiment of the present invention while being loaded from the bending-moment loading “Fy”;

FIG. 11B is a sectional view along a section “A-A” in FIG. 11A;

FIG. 12A is a schematic view of the intelligent tool holder of the second embodiment of the present invention while being loaded from a bending-moment loading “-Fx”;

FIG. 12B is a sectional view along a section “A1-A1” in FIG. 12A;

FIG. 13 is a schematic view of the intelligent tool holder of the second embodiment of the present invention while being loaded from an axial force loading “Fz”;

FIG. 14A is a schematic view of the intelligent tool holder of the second embodiment of the present invention while being loaded from a torque “Tz”; and

FIG. 14B is a sectional view along a section “B-B” in FIG. 14A.

### DETAILED DESCRIPTION OF THE PRESENT INVENTION

The following description is of the best-contemplated mode of carrying out the present invention. This description is made for the purpose of illustrating the general principles of the present invention and should not be taken in a limiting sense. The scope of the present invention is best determined by reference to the appended claims.

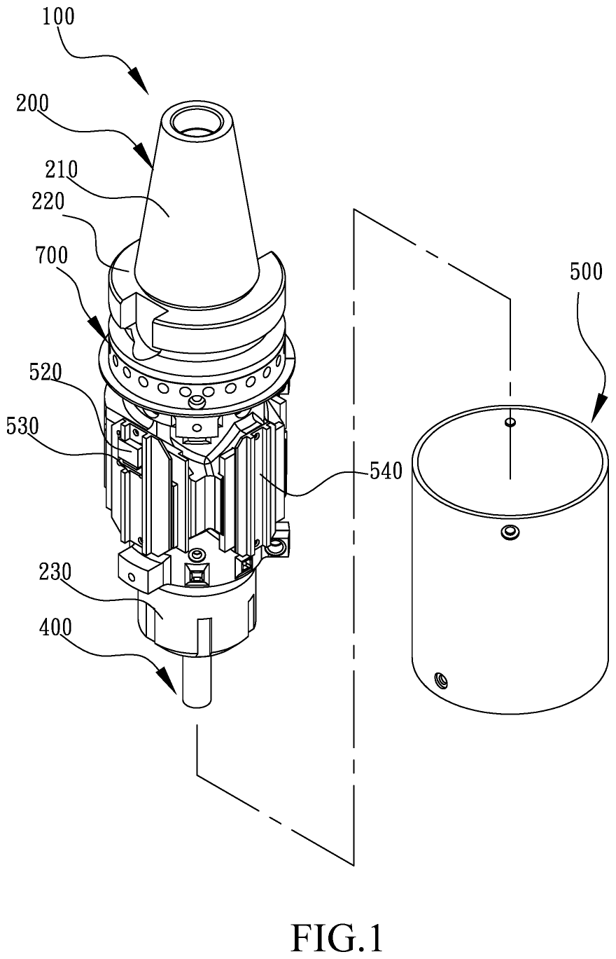

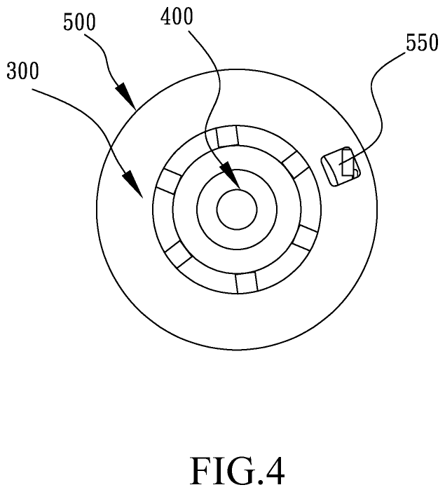

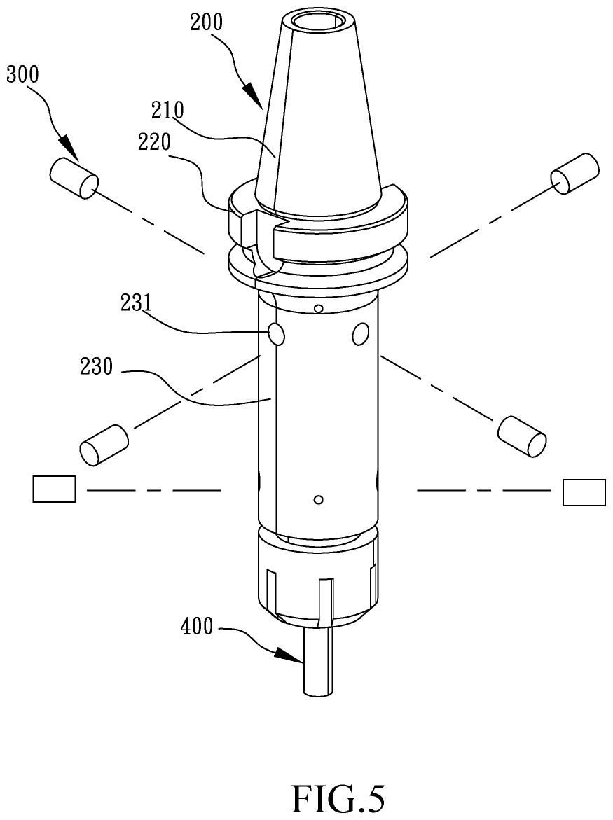

In FIGS. 1 to 5, these exploded views and assembled schematic views show that an intelligent tool holder 100 of a first embodiment of the present invention comprises a tool-holder main body 200, a plurality of sensing elements 300, a processing tool 400 and a sensing reading device 500.

The tool-holder main body 200 comprises a main shaft joining portion 210, a clamping portion 220 and a connecting portion 230. The processing tool 400 is connected to a distal end of the connecting portion 230. The main shaft joining portion 210 is utilized to connect to a main shaft of a processing device such as milling machine, drilling machines, lathe machines or sawing machines. The clamping portion 220, which is provided for being clamped for the use of a tool magazine or a tool change process, is connected to the main shaft joining portion 210 and the connecting portion 230. The connecting portion 230 is utilized to connect the processing tool 400. The processing tool 400 can be milling cutters, drilling bits, lathe cutters and saw blades, etc.

In actual applications, the connecting portion 230 is provided with a plurality of embedded holes 231 respectively embedded with a sensing element 300 therein to kinetically detect sensed data including stress and strain of the tool-holder main body 200 which are correspondingly formed as being loaded from the processing tool 400. In this embodiment, the sensing elements 300 can be piezoelectric sensors. The sensing elements 300 are utilized to perform a stratified detection to a bending-moment loading and a torque loading of the processing tool 400, and two symmetrically-configured embedded sensing elements 300 are utilized to detect each moment and each torque respectively.

The present invention applies the mechanics analysis to obtain the positions of the tool-holder main body 200 where are capable of forming a maximum stress and a maximum stain while being correspondingly loaded from a tool tip of the processing tool 400. The outcome shows that the position capable of forming a maximum stress caused by the bending-moment loading is to be near to the main shaft joining portion 210. Accordingly, a stratification design is applied to detect the bending-moment loading and the torque loading so as to decouple force signals output from the sensing elements 300, and a symmetrical design of two symmetrically-configured embedded sensing elements 300 is applied to detect each moment “Mx and My” and each torque “Tz”, thus to increase the sensing precision of the forced tool-tip of the processing tool 400. Based on the mechanics analysis, while the tool tip of the processing tool 400 is loaded from the bending moments “Mx and My”, the bending-moment detection sensing elements 300 can output a corresponding voltage signal, but the torque-detection sensing elements 300 influenced therewith still can output a partial voltage signal. For obtaining a better decoupling effect, the locations of the embedded holes of two sets of upper and lower sensing elements 300 are mutually staggered at a 45-degree angle formed therebetween, thus to improve the force coupling effect.

As shown in FIGS. 1 to 4, the sensing reading device 500 has a housing 500h which is utilized to cover the connecting portion 230 of the tool-holder main body 200. A sensing reading module 510 disposed in a space located between the housing 500h of the sensing reading device 500 and the connecting portion 230 of the tool-holder main body 200 is connected to each sensing element 300 to read the sensed data (e.g., voltage signal) of the sensing element 300 transmitted therefrom.

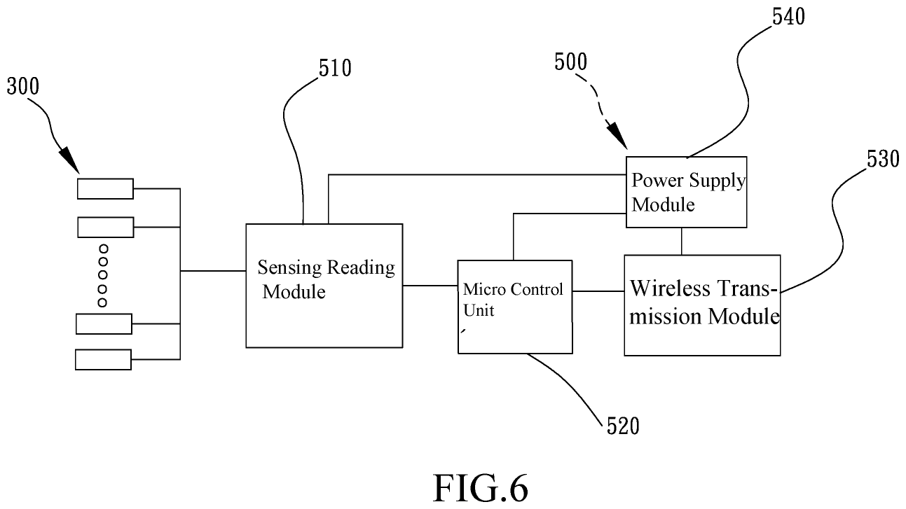

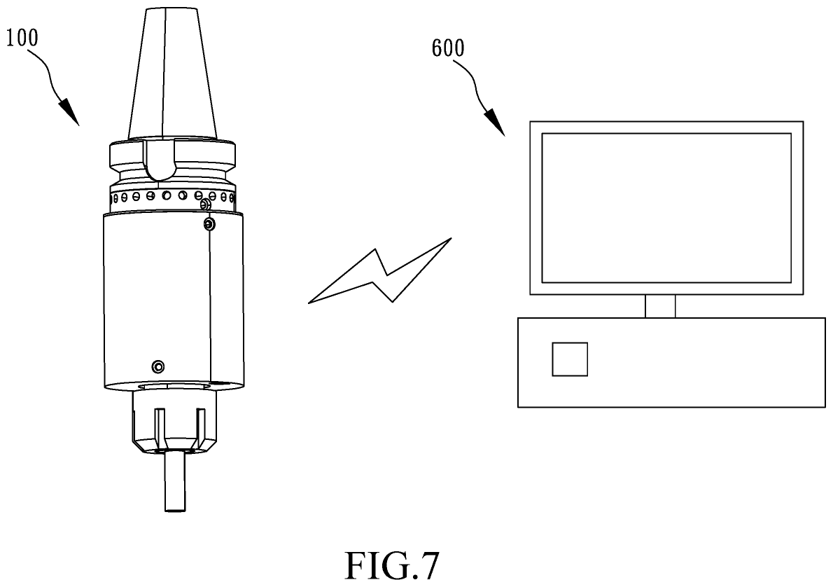

FIG. 6 shows a circuit block diagram of the intelligent tool holder of the present invention. The sensed data (e.g., voltage signal) of the sensing elements 300 are transmitted to the sensing reading module 510 which includes a reading circuit composed of a charge amplifier and a filter component. Then, the signals transmitted from the sensing reading module 510 are transmitted to an analog/digital converter (not shown in Figs.) to convert into digital signals. Then, the digital signals transmitted from the analog/digital converter are encrypted by a micro control unit (MCU) 520 and transmitted to an external monitoring device 600 (shown in FIG. 7) via a wireless transmission module 530 connected to the MCU 520, thus to perform a manufacturing real-time dynamic monitoring process. The monitoring device 600 comprises an analysis module which is utilized to receive and compare the sensed data transmitted from the wireless transmission module 530 to the tool-holder characteristic data stored in database, thus to estimate the conditions of the processing tool 400 of the intelligent tool holder 100 such as wearing, damage, life span, etc.

The sensing reading device 500 further comprises a power supply module 540 which supplies electricity to electric modules including the sensing reading module 510, the MCU 520 and the wireless transmission module 530. The power supply module 540 comprises a battery such as a disposable battery, a rechargeable battery or a wireless-charging battery. If the rechargeable battery is put in use in the power supply module 540, the rechargeable battery of the power supply module 540 can be charged when the intelligent tool holder 100 is not in use, i.e., the power supply module 540 is needed not to be replaced.

If the wireless-charging battery is put in use in the power supply module 540, the wireless-charging battery of the power supply module 540 can be charged at a predetermined period of time when the intelligent tool holder 100 is in use, i.e., the power supply module 540 is needed not to be replaced.

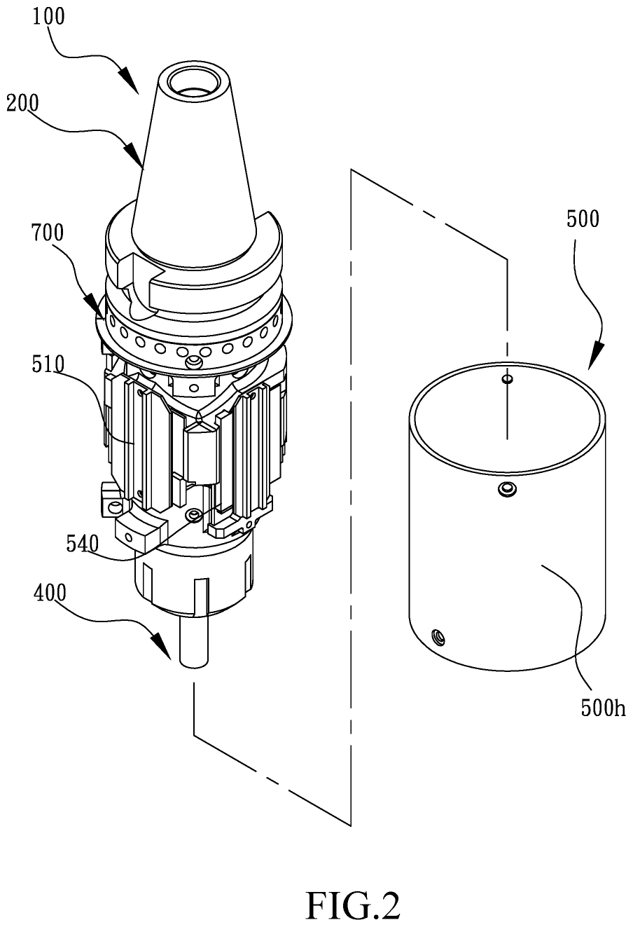

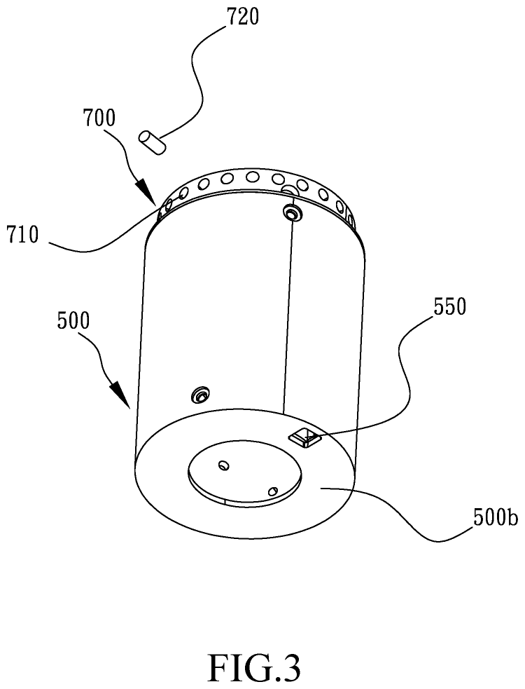

With the design of the housing 500h of the sensing reading device 500, the sensing reading device 500 can be installed on the connecting portion 230 of the tool-holder main body 200 along the processing tool 400 via a fixation means such as screw connections, plug-in connections or others. As to the space arrangement of the intelligent tool holder 100, the aforementioned electrical components including the sensing reading module 510, the MCU 520, the wireless transmission module 530, the power supply module 540 (except the sensing elements 300) are disposed in the space located between the housing 500h of the sensing reading device 500 and the connecting portion 230 of the tool-holder main body 200. It is noted that weight-basis is the major principle in the structural configuration of the intelligent tool holder 100, arranging the above-mentioned components on the inner wall of the housing 500h of the sensing reading device 500 with balancing weight at the same level. Referring again to FIGS. 1 and 2, a counterweight ring 700 is disposed in the direction of being near to the clamping portion 220. The counterweight ring 700 disposed on one side of the housing 500h of the sensing reading device 500 has an outer periphery provided with a plurality of assembly holes 710 utilized to assemble counterweight elements 720. In this embodiment, the counterweight ring 700 is annularly and equidistantly provided with thirty-six assembly holes 710, i.e., any two adjacent assembly holes 710 have a central angle of 10 degrees formed therebetween. In this embodiment, the counterweight element 720 is a screw and the assembly hole 710 is a threaded hole. In FIG. 3, a bottom cap 500b disposed in the direction of being distant from the counterweight ring 700 is provided with one wireless transmission terminal 550. That is, the wireless transmission terminal 550 is located at the end surface of the housing 500h to be near to an outer periphery surface thereof. The sensing reading module 510, the micro control unit 520, the wireless transmission module 530 and the depressurization module 34 are bonded to the inner wall of the housing 500h of the sensing reading device 500 by adhesives, based on the weight-basis method to arrange the above-mentioned components onto the inner wall of the housing 500h of the sensing reading device 500 with a substantial balancing weight at the same level, thus to attain a dynamic balance design. With the counterweight ring 700 disposed on one side of the housing 500h of the sensing reading device 500 to be near to the clamping portion 220 of the tool-holder main body 200, a center of gravity offset of the tool-holder main body 200 possibly caused by these electrical components having different sizes and individual weights can be prevented. The counterweight elements are screws adjustably connected to the corresponding assembly holes 710. Therefore, with the adjustment of the screw-lock depths of the counterweight elements connected to the assembly holes 710, the gravity of the tool-holder main body 200 can be determined and adjustably resumed at a gravity balance status, thereby avoiding the instability occurred while a work piece is cut by the tool-holder main body 200 in the cutting processing and reducing the defective rate of products. With the design of the modularized sensing system in the intelligent tool holder 100 and the detachable sensing reading device 500, the convenience of use of the intelligent tool holder 100 is greatly promoted, thus to facilitate the processes of component replacement and the disorder detection mechanism and reduce the maintenance cost to complete.

Note that the intelligent tool holder of the present invention provides the main features as follows: providing a multi-axis decoupling and high-sensitivity sensing mechanism, applying a bending-moment loading and a torque loading to perform a stratified detection, cooperating with a piezoelectric active power of the piezoelectric elements, increasing sensing properties and lowering the coupling effects, and using the symmetrically-configured piezoelectric elements to detect the global forced condition in the processing procedure. The sensed data detected by the sensing elements 300 includes vibration signals, stress signals and torque signals of the tool-holder main body 200 in the processing procedure. The external monitoring device 600 receives the sensed data transmitted from the wireless transmission module 530, and the analysis module installed in the external monitoring device 600 is utilized to compare the sensed data transmitted from the wireless transmission module 530 to the tool-holder characteristic data stored in database, thus to determine whether the sensing information is normal or not when the tool-holder main body 200 is operated in the processing procedure and to estimate the current conditions of the processing tool 400 of the intelligent tool holder 100 such as wearing, damage, life span, etc.

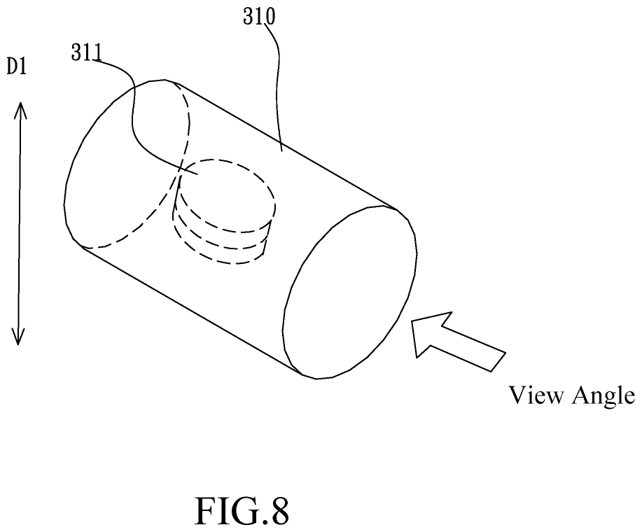

In FIGS. 8 to 14A and 14B, an exemplary example of a second embodiment of an intelligent tool holder of the present invention is illustrated. The main structure and features of the intelligent tool holder of the second embodiment identical to the same of the first embodiment of the present invention are omitted. A rectangular coordinate system XYZ is shown in some figures to define allocations and orientations of the second embodiment of the intelligent tool holder of the present invention.

The sensing element 300 are divided into a plurality of first sensors 310 and a plurality of second sensors 320. The embedded holes 231 are divided into a plurality of first embedded holes 2311 and a plurality of second embedded holes 2312, in which the first embedded holes 2311 are disposed at a region of the connecting portion 230 to be near to the main shaft joining portion 210 and formed with at least one stratified loop of annularly-arranged first embedded holes 2311 and the first embedded holes 2311 in the same stratified loop are symmetrically configured so that the first sensors 310 embeddedly disposed in the first embedded holes 2311 are symmetrically configured in the same stratified loop. Meanwhile, the second embedded holes 2312 are disposed at a region of the connecting portion 230 to be distant from the main shaft joining portion 210 and formed with at least one stratified loop of annularly-arranged second embedded holes 2312 and the second embedded holes 2312 in the same stratified loop are symmetrically configured so that the second sensor 320 embeddedly disposed in the second embedded holes 2312 are symmetrically configured in the same stratified loop.

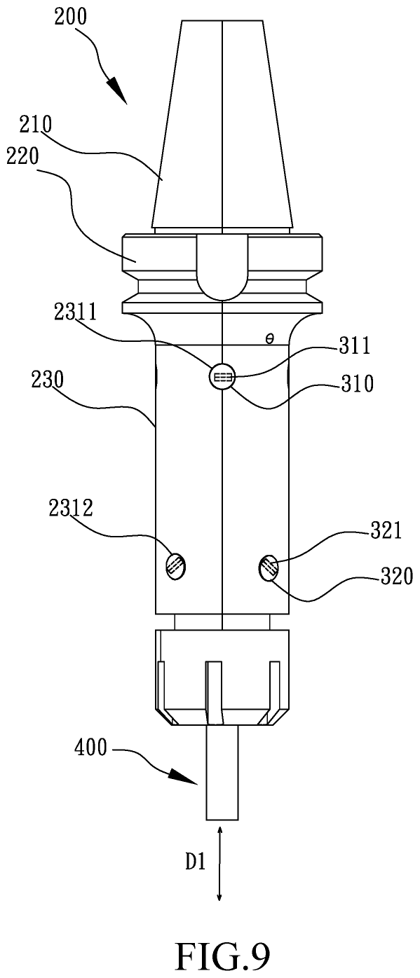

In FIG. 9, the locations of the first embedded holes 2311 and the locations of the second embedded holes 2312 are mutually staggered and not arranged at the same straight line in a first direction D1. With the applications of the mechanics analysis, the first and second sensors 310 and 320 are utilized to detect the sensed data including stress and strain of the tool-holder main body 200 which are correspondingly formed as being loaded from the processing tool 400. In this embodiment, the first direction D1 can be an axial direction of the intelligent tool holder 100.

It is understood in FIG. 9 in that the amount of the symmetrically-arranged first embedded holes 2311 is four, and the amount of the symmetrically-arranged second embedded holes 2312 is four.

In this embodiment, the first and second sensors 310 and 320 are piezoelectric sensors. The embeddedly-disposed first and second sensors 310 and 320 are substantially perpendicular to the first direction D1, viewed by a view angle (as shown in FIG. 8) to observe the first and second sensors 310 and 320. Each first sensor 310 is configured therein with a first piezoelectric element 311 which is compressed in a direction that is identical to the first direction D1.

Each second sensor 320 is configured therein with a second piezoelectric element 321 which is compressed in a direction that is inclined to the first direction D1 and an intersection angle formed therebetween is 45 degrees.

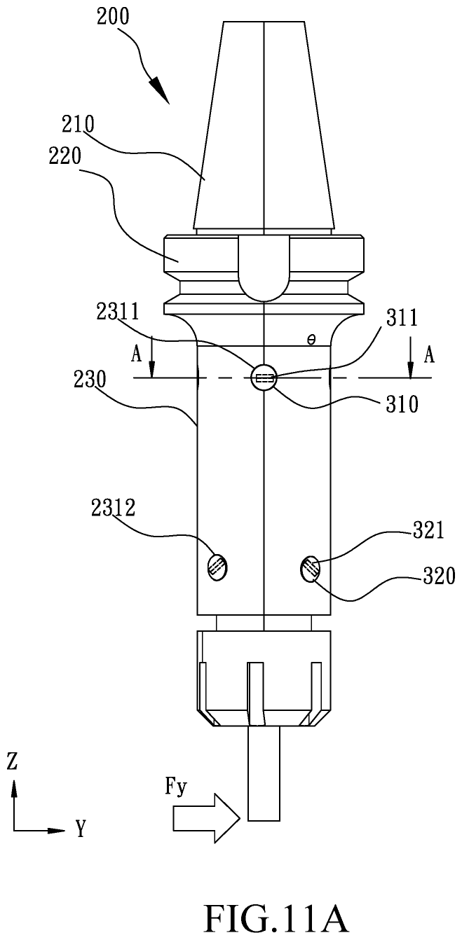

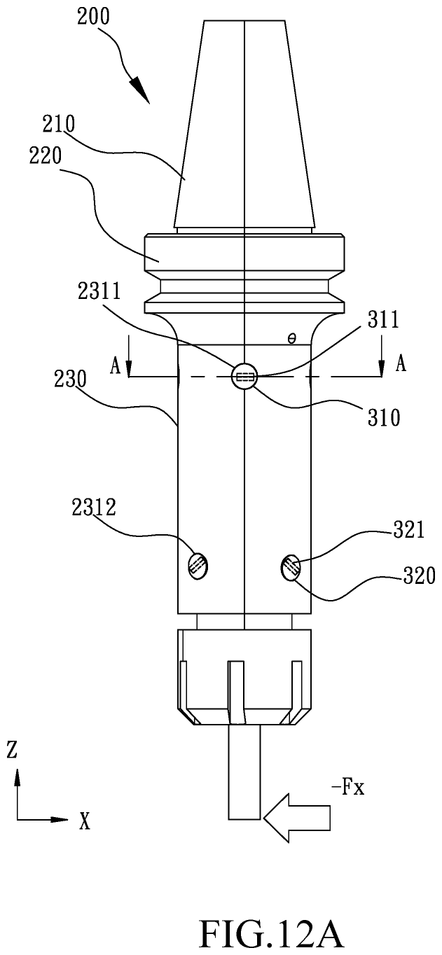

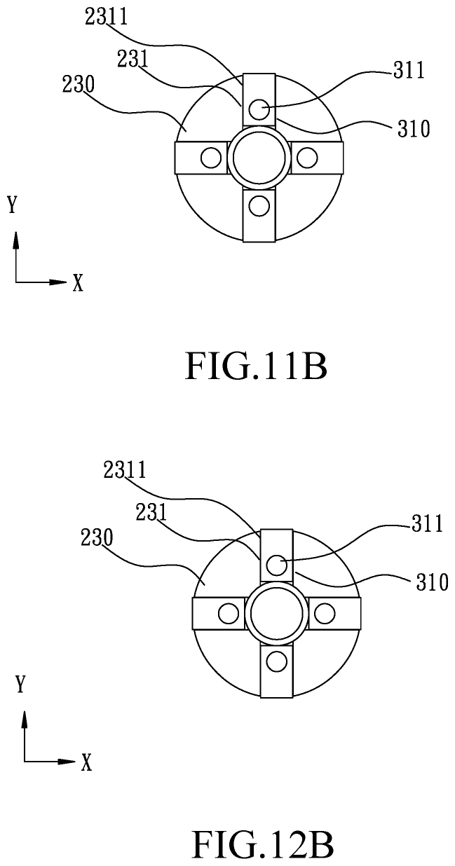

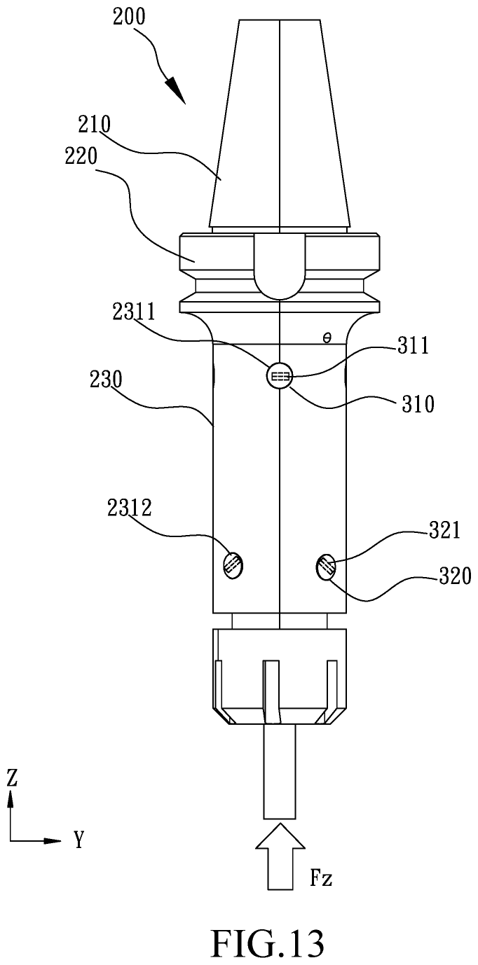

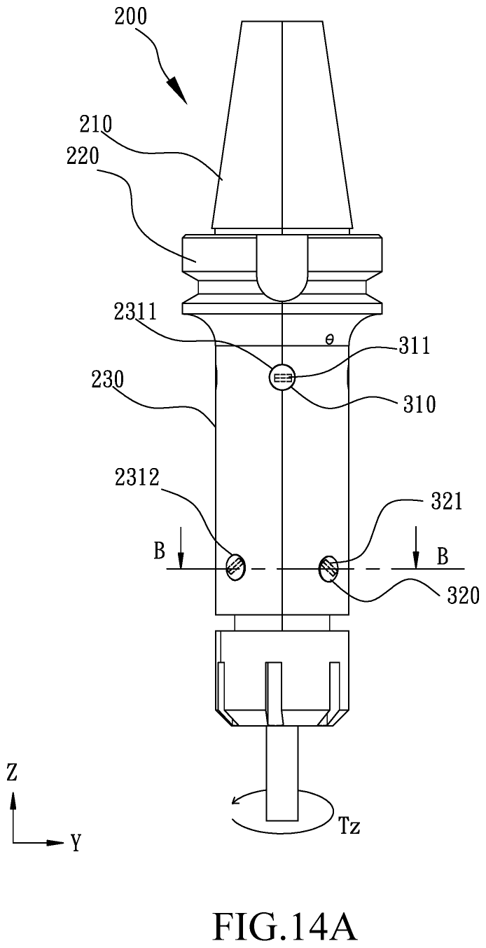

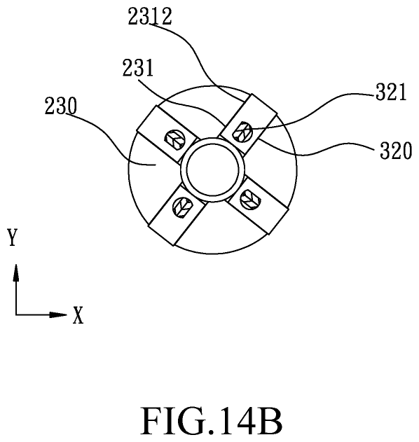

The present invention applies the mechanics analysis to obtain the positions of the tool-holder main body 200 where are capable of forming the maximum stress and the maximum stain while being correspondingly loaded from the tool tip of the processing tool 400. The analysis outcome shows that the position capable of forming the maximum stress caused by the bending moment is to be near to the main shaft joining portion 210. The present invention applies the stratification design to detect the bending moments “Mx and My” and the torque “Tz” so as to decouple the force signal output from the first and second sensors 310 and 320 of the sensing elements 300. The first sensors 310 are utilized to detect the bending-moment loading “Fy” (shown in FIG. 11A) and “-Fx” (shown in FIG. 12A) of the processing tool 400 while the processing tool 400 is operated in the processing procedure. Besides, the first sensors 310 are also utilized to detect the axial force loading “Fz” (shown in FIG. 13) of the processing tool 400 while the processing tool 400 is operated in the processing procedure. The second sensors 320 are utilized to detect the torque “Tz” (shown in FIG. 14A) of the processing tool 400 while the processing tool 400 is operated in the processing procedure. With the symmetrical design of two symmetrically-configured embedded first sensors 310 (shown in FIGS. 11B and 12B) to detect each moment “Mx and My” and of two symmetrically-configured embedded second sensors 320 (shown in FIG. 14B) to detect the torque “Tz”, thus to increase the sensing precision of the forced tool-tip of the processing tool 400. Based on the mechanics analysis, while the tool tip of the processing tool 400 is loaded from the bending-moment loading or acting force “Fy” and “-Fx”, the bending-moment detection first sensors 310 can output a corresponding voltage signal, but the torque-detection second sensors 320 influenced therewith still can output a partial voltage signal. For obtaining an excellent decoupling effect, the locations of the embedded holes of two sets of upper and lower sensors, i.e., the first and second sensors 310 and 320, are mutually staggered at an angle (e.g., 45 degrees) formed therebetween, thus to improve the force coupling effect.

The decoupling means to establish a suitable mechanism in an original multivariable sensing system to eliminate an intercoupling of various variables therebetween, and therefore each input can simply influence its corresponding output and each output can be simply controlled by the input, thereby converting the original multivariable sensing system to a multiple single-input single-output system. In the piezoelectric sensors (the first and second sensors 310 and 320) of the present invention, the polarization directions of the first and second piezoelectric elements 311 and 321 are disposed in piezoelectric forced directions which are expected to detect the loadings to directly produce a voltage signal output corresponding the loadings, instead of a massive calculation of a strain gauge sensing system. Therefore, a sufficient, great decoupling effect can be obtained by designing the embedded locations and the placement or deviation angles of sensors.

In one of the technical features of the present invention, the piezoelectric sensors are divided into two sets of first and second sensors 310 and 320 arranged in a stratified configuration (as shown in FIG. 9) to respectively detect moments, axial forces and torques which are produced while the tool-holder main body 200 is forced. In the decoupling method of the piezoelectric element, which simply provides the locations and the angles of the piezoelectric sensors (the first and second sensors 310 and 320) to enable the polarization directions of piezoelectric sheets of the first and second piezoelectric elements 311 and 321 of the loaded sensing devices to be disposed in the position having the maximum stress of the loadings thereof and the minimum-stress positions of other loadings, thus to obtain the force signal decoupling effect. For example, a polarization direction of a PZT (Pb(ZrTi)O₃) piezoelectric ceramic is a normal direction of the surface of piezoelectric sheets.

That is, the polarization direction of the PZT piezoelectric ceramic utilized for detecting the moments “Mx and My” acting on the tool-holder main body 200 is disposed in the direction of the internal maximum principal stress thereof, and the polarization direction of the PZT piezoelectric ceramic utilized for detecting the torque “Tz” acting on the tool-holder main body 200 is disposed in the direction of the internal maximum principal stress thereof.

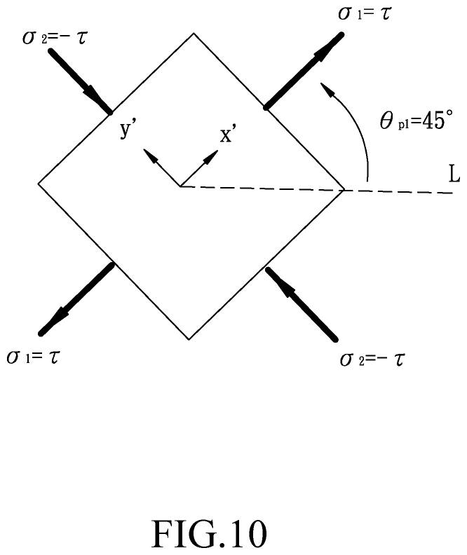

In FIG. 10, a schematic view shows values and directions of a maximum principal stress of the intelligent tool holder of the second embodiment of the present invention while being loaded from the pure torsion. Based on the mechanics analysis, the maximum principal stress “σ₁” of the tool-holder main body 200 is located in the direction of 45 degrees (θₚₗ) with respect to a dotted line “L” while the tool-holder main body 200 is loaded from the torque “Tz”, wherein a symbol “τ” shows a shear force formed by the torsion. Therefore, except for the stratified and staggered embedded locations of the configuration of the first and second sensors 310 and 320 described in FIG. 9, the torque sensing module (the second sensors 320) should be disposed at the deviation angle of 45 degrees, thus to achieve an optimal decoupling configuration.

In actual applications, the configuration of the above-mentioned sensors is simply designed for detecting the bending moments “Mx and My” and the torque “Tz”, and the symmetrically-configured sensors are designed for detecting the global forced condition in the processing procedure. Accordingly, it is required to provide a decoupling operational mechanism for processing the output outcomes of final force signals of the bending moments “Mx and My”, the torque “Tz” and the axial force loading “Fz”, thus to convert these final force signals to the corresponding voltage signal output of the bending moments “Mx and My”, the torque “Tz” and the axial force loading “Fz”.

According to the outcomes of kinetics-theory derivation and numerical analysis simulation verification, an optimal decoupling output operation of the sensors of the present invention with the stratified configuration and the placement angles can be obtained. The detection method of the bending moments “Mx and My” is determined by an output outcome subtraction of two corresponding sensors in the sensing modules for the bending moments “Mx and My”. The detection method of the torque “Tz” is determined by an output outcome addition of two corresponding sensors in the sensing modules for the torque “Tz”. The detection method of the axial force loading “Fz” is determined by an output outcome addition of four sensors in the sensing modules for the bending moments “Mx and My”. Accordingly, this decoupling mechanism can maximize the corresponding detected outcome values of four loadings (i.e., the bending moments “Mx and My”, the torque “Tz” and the axial force loading “Fz”), but the detected outcome having the smallest value is obtained in the other loading direction, thus to obtain the optimal signal decoupling output effect of four loadings.

While the present invention has been described by way of example and in terms of the preferred embodiments, it is to be understood that the present invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An intelligent tool holder, comprising:
a tool-holder main body comprising a connecting portion which is utilized to connect a processing tool and provided with a plurality of embedded holes respectively embedded with a sensing element therein to kinetically detect sensed data including stress and strain of the tool-holder main body which are correspondingly formed as being loaded from the processing tool; and
a sensing reading device comprising a housing to outwardly cover the connecting portion of the tool-holder main body, and a sensing reading module being disposed in a space located between the housing of the sensing reading device and the connecting portion of the tool-holder main body and connected to each sensing element to read the sensed data of the sensing element transmitted therefrom.

2. The intelligent tool holder as claimed in claim 1, wherein the tool-holder main body sequentially comprises a main shaft joining portion, a clamping portion and the connecting portion, in which the clamping portion having one end connected to the main shaft joining portion and the other end connected to the connecting portion is arranged in accordance with a first direction, the embedded holes comprising first embedded holes which are disposed at a region of the connecting portion to be near to the main shaft joining portion and formed with at least one stratified loop of annularly-arranged first embedded holes and the first embedded holes in the same stratified loop are symmetrically configured and second embedded holes which are disposed at a region of the connecting portion to be distant from the main shaft joining portion and formed with at least one stratified loop of annularly-arranged second embedded holes and the second embedded holes in the same stratified loop are symmetrically configured, the sensing element disposed in the first embedded holes are defined as a plurality of first sensors and the sensing element disposed in the second embedded holes are defined as a plurality of second sensors, the first sensors located at the same stratified loop are symmetrically configured, and the second sensor located at the same stratified loop are symmetrically configured.

3. The intelligent tool holder as claimed in claim 2, wherein the first sensors are utilized to detect a bending-moment loading and/or an axial force loading of the processing tool and the second sensor are utilized to detect a torque loading of the processing tool while the processing tool is operated in a processing procedure.

4. The intelligent tool holder as claimed in claim 2, wherein the locations of the first embedded holes and the locations of the second embedded holes are mutually staggered and not arranged at the same straight line in the first direction.

5. The intelligent tool holder as claimed in claim 4, wherein each first sensor is configured therein with a first piezoelectric element which is compressed in a direction that is identical to the first direction.

6. The intelligent tool holder as claimed in claim 5, wherein each second sensor is configured therein with a second piezoelectric element which is compressed in a direction that is inclined to the first direction and an intersection angle formed therebetween comprises 45 degrees.

7. The intelligent tool holder as claimed in claim 1, wherein the sensing elements comprises piezoelectric sensors.

8. The intelligent tool holder as claimed in claim 2, wherein the sensing elements comprises piezoelectric sensors.

9. The intelligent tool holder as claimed in claim 1, wherein the sensing elements are utilized to perform a stratified detection to a bending-moment loading and a torque loading of the processing tool, and two symmetrically-configured embedded sensing elements are utilized to detect each moment and each torque respectively.

10. The intelligent tool holder as claimed in claim 1, wherein the housing is outwardly covered on the connecting portion of the tool-holder main body, a sensing system is surroundingly disposed between the housing and the connecting portion of the tool-holder main body, a counterweight ring disposed on one side of the housing is provided with a plurality of assembly holes utilized to assemble counterweight elements, and a bottom cap disposed in the direction of being distant from the counterweight ring is provided with at least one wireless transmission terminal.

11. The intelligent tool holder as claimed in claim 10, wherein the sensing system at least comprises the sensing reading module, a micro control unit utilized to perform a signal process to the sensed data read by the sensing reading module, a wireless transmission module connected to the micro control unit and utilized to encrypt and send the signal processed by the micro control unit to an external monitoring device, a depressurization module and a power supply module.

12. The intelligent tool holder as claimed in claim 10, wherein the counterweight ring having an outer periphery annularly and equidistantly provided with the assembly holes.

13. The intelligent tool holder as claimed in claim 10, wherein the counterweight element comprises be a screw and the assembly hole comprises a threaded hole.
